(19) United States
(12) Patent Application Publication
(10) Pub. No.: US 2005/0000282 A1
(43) Pub. Date: Jan. 6, 2005

(54) Temperature control of a flow sensor having pulse-width modulation

(76) Inventors: Uwe Konzelmann, Asperg (DE); Tobias Lang, Stuttgart (DE)

Correspondence Address: KENYON & KENYON, ONE BROADWAY, NEW YORK, NY, 10004, US

(21) Appl. No.: 10/840,691

(22) Filed: May 5, 2004

(30) Foreign Application Priority Data
May 16, 2003 (DE) 10322013.5

(51) Int. Cl. G01F 1/68

(52) U.S. Cl. 73/204.15

(57) ABSTRACT

A flow sensor for internal combustion engines in which the temperature control of a heating resistor element is implemented by pulse-width modulation.

### FIELD OF THE INVENTION

The present invention relates to a flow sensor for an internal combustion engine, having at least one electrical heating resistor element and at least one controller for temperature control of the heating resistor element.

### BACKGROUND INFORMATION

In flow sensors for internal combustion engines, which may be configured as hot-film air-mass meters or as hot-wire air mass meters, a heating resistor element is heated to a specific temperature. This is accomplished by applying an electric voltage, which is metered such that it results in a predefined temperature of the heating resistor element. As a rule, the temperature of the heating resistor element is specified as a function of the ambient temperature. The temperature control is currently realized by an electronic circuit controlling the voltage applied at the heating resistor element. A disadvantage of this circuit is that the on-board vehicle voltage present in the vehicle electrical system of the internal combustion engine or the motor vehicle must be reduced by an amount wire ΔU in order to obtain the desired voltage at the heating resistor element. Differential voltage ΔU occurs in the control electronics and causes a power loss Pₗₒₛₛ=ΔU*I_{H},I_{H} denoting the current flowing through the heating resistor element.

The power loss leads to heating of the electronic circuit. The heating of the electronic circuit causes thermal drift, which has a negative effect on the signal quality of the flow sensor. Furthermore, the generated heat may shorten the service life of the control electronics.

### SUMMARY OF THE INVENTION

In a flow sensor, according to the present invention, for an internal combustion engine, having at least one electrical heating resistor element, at least one temperature sensor and temperature control of the heating resistor element, the temperature control of the heating resistor element is accomplished by pulse-width modulation of heating voltage U_{H}.

Heating voltage U_{H} is equal to, or slightly lower than, the on-board vehicle voltage of the internal combustion engine or the motor vehicle, so that the voltage drop in the control electronics is considerably reduced. The power control is then implemented in that a controllable switch of the power electronics briefly closes the electrical connection between the heating resistor element and the vehicle electrical system and then opens it again. The power of the heating resistor element may be controlled via the correlation between the times during which the electrical connection is closed and the times during which the electrical connection is interrupted. This type of power control is referred to as pulse-width modulation and is known from other application fields.

Although the full on-board vehicle voltage is available at the switch when the switch of the control electronics is open, there is no current flow during this time, so that no power loss occurs in the control electronics in this switching state. When the switch of the control electronics is closed, barely any voltage drop takes place at the switch, so that no power loss occurs in the control electronics in this switching state either.

As a result, virtually no heating of the control electronics takes place in the temperature control according to the present invention. As a result, the undesired thermal drift of the control electronics is virtually eliminated. This improves the signal quality of the flow sensor and the service life of the control electronics as well. The control concept according to the present invention is also advantageous from the standpoint of costs.

In one variant of the flow sensor according to the present invention it has proven advantageous if the temperature control of the heating resistor element includes a controllable switch, in particular a transistor, which is closed and opened as a function of the temperature of the heating resistor element.

It is particularly advantageous in this context if the cycle time of the switch is considerably shorter than the thermal time constant of the heating resistor element, including its carrier material (such as a membrane), since this measure achieves a temperature of the heating resistor element that is constant over time, notwithstanding the fact that the supply of the electrical energy is not constant but the electrical energy is transmitted at short time intervals instead, at high power, these being followed by time intervals having an approximately equal length during which no power is transmitted.

### BRIEF DESCRIPTION OF THE DRAWINGS

FIG. 1 shows a schematic representation of a hot-film air mass meter.

FIG. 2 shows a simplified representation of a temperature control of the heating resistor element according to the present invention.

### DETAILED DESCRIPTION

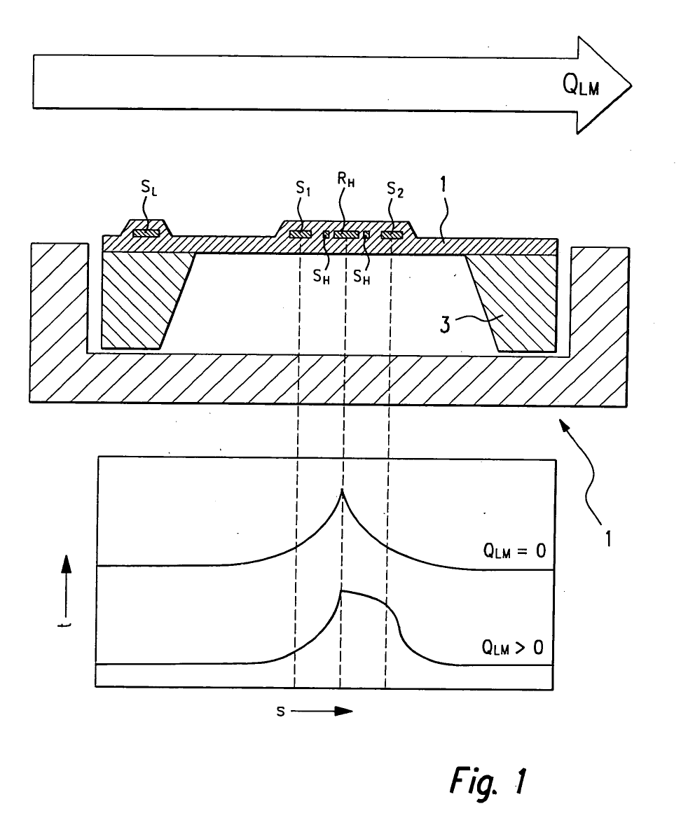

FIG. 1 schematically shows a hot-film air mass meter 1. Hot-film air mass meter 1 is made up of a silicon chip 3 provided with a recess in the region of a heating resistor element R_{H}. In the immediate vicinity of heating resistor element R_{H} are heating-temperature sensors S_{H} with whose aid the temperature of heating resistor element R_{H} is measured. An air temperature sensor S_{L} is provided on silicon chip 3. Using the values measured with the aid of heating-temperature sensors S_{H} and air temperature sensor S_{L}, the temperature of heating resistor element R_{H} is controlled to a constant excess temperature with respect to the air temperature. This temperature control is implemented by controlling the electrical power supplied to heating resistor element R_{H}.

The output variable of the hot-film air mass sensor shown in FIG. 1 is the temperature of the air above hot-film air mass sensor 1, this temperature being determined by two temperature sensors S₁ and S₂. The air flow is indicated in FIG. 1 by the arrow denoted by Q_{LM}.

Shown below hot-film air mass meter 1 is the temperature profile when the air is at rest (Q_{LM}=0) and when an air flow is present (Q_{LM}>0). It is apparent that the temperature difference between temperature sensors S₁ and S₂=0 when the air is at rest. When an air flow is present, temperature sensor S₁ positioned upstream in the flow direction detects a lower air temperature than temperature sensor S₂ located downstream from heating resistor element R_{H}. The measure of the temperature difference between temperature sensors S₁ and S₂ is a measure of air-mass flow Q_{LM} flowing via the flow sensor.

The present invention is not restricted to hot-film air mass meters 1 according to FIG. 1, but may also be used in air-mass meters without temperature sensors, for instance, which work according to the twin-heater principle.

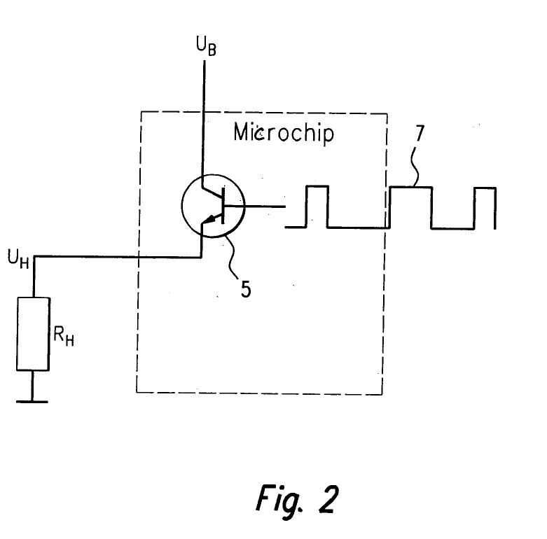

The power control, according to the present invention, of heating resistor element R_{H} is explained on the basis of FIG. 2. The power control is accommodated on a microchip. The microchip controls the electrical connection between on-board vehicle voltage U_{B} and heating resistor element R_{H}. According to the present invention, the temperature control of heating resistor element R_{H} provides for the electrical connection between on-board vehicle voltage U_{B} and heating resistor element R_{H} to be opened and closed at brief time intervals, using a controllable switch 5. By the correlation between the periods during which the electrical connection between on-board vehicle voltage U_{B} and heating resistor element R_{H} is established and the periods during which this electrical connection is interrupted, a power control of heating resistor element R_{H} is implemented. This type of power control is known as pulse-width modulation. FIG. 2 illustrates this type of power control by a line 7.

When switch 5 is open, nearly the entire on-board vehicle voltage is present at switch 5. However, since no current flows through switch 5, no power loss occurs at switch 5 during this switching state.

When switch 5 is closed, full on-board vehicle voltage U_{B} is present at heating resistor element R_{H}, and a corresponding current flows through heating resistor element R_{H} causing it to warm up. The power loss of switch 5 in the closed state is very low compared to the electrical output of the heating resistor element, so that the power loss of switch 5 causes virtually no heating of the electronic control. As a result, there is practically no temperature drift of the electronic circuit, so that the output signal of the flow sensor according to the present invention is improved by the power control of heating resistor element R_{H} according to the present invention.

1. A flow sensor for an internal combustion engine comprising:
at least one electrical heating resistor element; and
a temperature control of the heating resistor element, the temperature control being implemented by pulse-width modulation of a heating current.

2. The flow sensor according to claim 1, wherein the flow sensor is implemented as a hot-film air mass meter.

3. The flow sensor according to claim 1, wherein the flow sensor is implemented as a hot-wire air flow meter.

4. The flow sensor according to claim 1, wherein the temperature control includes a controllable switch, which is closed and opened as a function of a temperature of the heating resistor element.

5. The flow sensor according to claim 4, wherein a cycle time of the switch is substantially shorter than a time constant of the heating resistor element.

6. The flow sensor according to claim 4, wherein the switch includes a transistor.

7. The flow sensor according to claim 1, further comprising at least one temperature sensor for detecting a temperature of the at least one electrical heating resistor element.
